(19) United States
(12) Patent Application Publication
(10) Pub. No.: US 2003/0004441 A1
(43) Pub. Date: Jan. 2, 2003

(54) Device for radial in depth skin therapy

(76) Inventor: Joze Jelenc, Podnart (SI)

Correspondence Address: ST. ONGE STEWARD JOHNSTON & REENS, LLC, 986 BEDFORD STREET, STAMFORD, CT, 06905-5619, US

(21) Appl. No.: 10/152,119

(22) Filed: May 21, 2002

(30) Foreign Application Priority Data
May 22, 2001 (SI) P-20010136

(51) Int. Cl. A61H 23/00

(52) U.S. Cl. 601/15

(57) ABSTRACT

The invention relates to an apparatus for radial in depth skin therapy comprising a bell-shaped housing (10), a cylinder (6) mounted in the housing (10), the said cylinder (6) having a band thicker wall at its bottom end to fit closely to the wall of the housing (10), a ball (4) or several balls or ball like bodies inserted at the bottom of the cylinder (6) so that they project out of the cylinder (6), and a connector 12, which is positioned on the upper side of the cylinder (6) and is intended for connection of the device to a suction source. The lower edge 8 of the housing (10) has a shape of an outwardly bended revers, which has a smoothly polished surface to enable tight and painless contact with the patient's skin and to allow massaging movements in all directions. Inside of said housing (10) an active chamber (20) is created, limited sideways by the inside wall of the bell-shaped housing (10) and on the upper side by the bottom surface of the cylinder (6). By means of a suction source connected to the device through the connector (12) in the active chamber (20) a suction effect is created to form a ring shaped skin fold (14). The massage effects can be enhanced and improved by cyclic variation of suction intensity as well as by mounting the means for infrared heating or/and ultrasound into the device.

### FIELD OF THE INVENTION

The invention relates to a device for radial in depth skin therapy enabling the in depth treatment of the tissue by massaging the skin surface with radial movements whereby a specific skin fold in a form of a ring is produced.

### BACKGROUND OF THE INVENTION

Various massaging techniques are known forming an extensive base for in depth therapies, where through pressure and various movements the living tissue is stroked, kneaded, pressed, or pinched.

For more effective in depth therapy through skin massage several apparatus have been designed to make massaging work easier and more efficient. The firms, which have such apparatus in their production program, are for example LPG Systems (U.S. Pat. No. 4,729,368), Enco, Weyergans High Care AG (EP1002510), Medic Systems (U.S. Pat. No. 6,090,055).

The massaging devices intended for certain kinds of depth therapy have in general a longish manually operated housing and the rollers or balls placed inside of the housing allowing simple mechanical massaging activities. By means of rollers or balls also suitable oil or salve is rubbed into the skin. As far as the in depth massaging effects are concerned, the efficiency of the mentioned apparatus is much smaller than the efficiency that can be achieved by the device which is the subject of the present invention.

In practice also in depth skin therapy devices having a bell-shaped housing with rounded bottom edge are in use, provided with a connection to a suction pump. During the massaging treatment, the skin is drawn into the suction chamber to form of a simple skin fold. Such devices are difficult to use, and it is especially difficult to carry out the massaging movements, therefore, they are more suitable for simple static treatment only.

Further, there are in depth skin therapy devices in use having a shape of a longish cuboid equipped with rollers or balls and the connection means for a suction pump. They allow the in depth skin therapy through treatment of a skin fold created by means of a suction pump. However, the known devices of this type have a substantial drawback resulting from their design: they allow particularly in line movements on the skin, while the execution of lateral movements is difficult and cannot been carried out without painful effect on the patient. Due to the concept and the embodiment of the said in depth skin therapy devices, the lateral part of the skin fold is left untreated causing a slightly painful or unpleasant feeling to the patient when movements in lateral direction are exerted.

A device for radial in depth skin therapy, which is the subject of the present invention, overcomes the drawbacks mentioned above.

A device for radial in depth skin therapy which is the subject of the present invention comprises a bell-shaped housing with its lower edge bended outwards to form a rounded revers with smoothly polished surface; a cylinder positioned inside the housing, the body of said cylinder being shaped to assume the appearance of a pot turned upside down and having on its down side, where one ball or several balls are inserted, a band of its wall thicker so as to extend almost next to the housing wall; and on the top of the said housing the connecting means for a suction source, which opens into the interior of the said housing in the position above the bottom of the said cylinder.

One ball or several balls or ball like bodies are inserted in separate recesses in said cylinder and are rotating smoothly when the device is moved, thereby enabling painless treatment throughout the course of the massaging procedure.

Inside the bell shaped housing an “active chamber” is created, which is limited by the inside wall of said housing and by the bottom part of said cylinder mounted in the housing.

All “active surfaces” which come into contact with the patient's skin, these are the inner surface of the bottom part of the housing together with the rounded revers of said housing and the bottom surface of said inner cylinder as well as the surface of revolvable balls, are processed suitably to ensure that the contact with said active surfaces does not cause any unpleasant feeling to the patient.

Inside the said active chamber, the vacuum conditions are established and, consequently, the skin on the massaging spot is sucked into the interior of the housing, where a characteristic ring shaped skin fold is formed. This effect has very favourable influence on blood circulation and intensifies also the lymphatic processes in massaged area. Additional therapeutic effects and an intensified effect of the radial movement can be achieved by varying the suction intensity, which can swing between two preset values. The therapeutic effects of the said device can be substantially enhanced also by implanting an ultrasonic head into the housing and by mounting several infrared-heating sources into the said housing.

To change the spot of the massaged area the device can be moved any direction, either in line or laterally. More over, different radial movements can also be performed which are especially important in all massage procedures.

The advantages of the design of the device according to invention enable best massaging effects in all points of “active surface” of the device and at the same time ensure, that during different movements of said device across the skin the patient does not suffer from any pain or unpleasant feelings.

### BRIEF DESCRIPTION OF DRAWINGS

The device for radial in depth skin therapy, which is the subject of the invention, is explained in detail by means of the following drawings which represent the examples of the realization, not implying any limitation to construction and embodiment of the said device.

FIG. 1 shows a schematic cross sectional view of the device according to invention

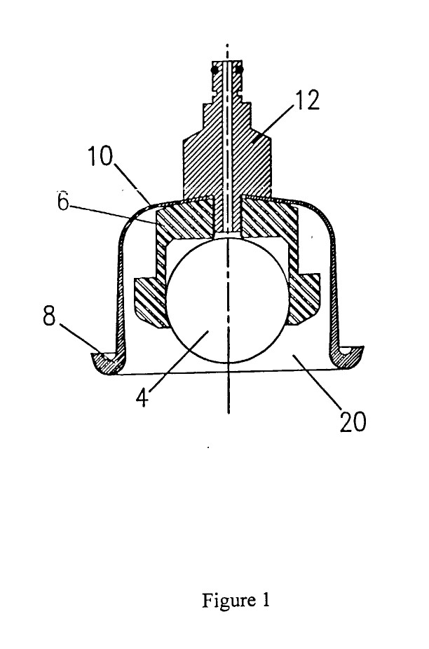

FIG. 2 shows a cross sectional view illustrating the forming of the skin fold in the device according to invention

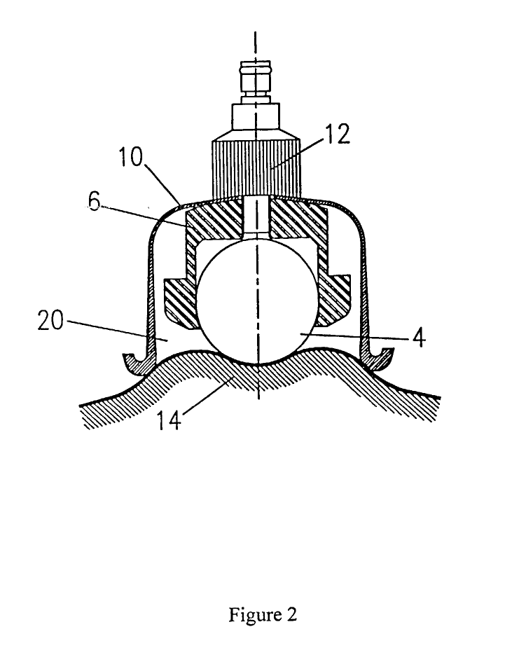

FIG. 3 shows a cross sectional view of the device according to invention with built in ultrasonic head

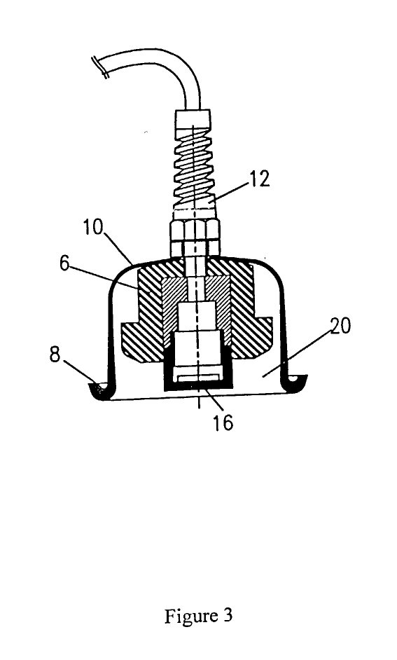

### DETAILED DESCRIPTION OF DRAWINGS

The device for radial in depth skin therapy, which is the subject of the present invention, comprises a bell-shaped housing 10, a cylinder 6 fixed in said housing, a ball 4 or several balls or ball like bodies inserted in the cylinder, and a connector 12 enabling the connection of the device to a suction source.

The housing 10 is actuated by hand and is therefore shaped accordingly to enable simple manipulation during different massaging movements. The bottom edge 8 of the housing has a shape of an outwardly bended revers with a smoothly polished surface to enable tight and painless contact with the patient's skin as well as massaging movements in all directions.

On the top of the housing 10 a connector 12 for a suction source is provided, which opens into the interior of the housing 10 in the position above the cylinder 6 and ensures hermetic interconnection between the inside of the housing 10 and the suction source.

The cylinder 6, which is mounted in the housing 10 and is formed so as to match to the inside wall of the housing 10, includes the bearings for a ball 4 or several balls or ball like shaped bodies. During the massage movements a ball 4 or several balls or ball like shaped bodies are rotating freely in their bearings and fit closely to skin fold 14 thereby enabling painless massaging and massaging movements in all directions.

Between the cylinder 6, the lower part of the housing 10 and the specially rounded bottom edge 8 of the housing 10 an active chamber 20 is created, in which a ring shaped skin fold 14 is formed during the massaging procedure as a result of the suction action caused by the suction system connected to the device. The suction intensity can be constant or can vary at a defined rate. The parameters of the suction can be adjusted according to the expected effects of the massage treatment. Cyclic variation of suction produces the effect of successive pull in and release of the skin fold 14, thereby stimulating the muscle tonus in a similar way as by kneading.

Favourable therapeutic effects of the device for radial in depth skin therapy can be improved by building in an ultrasonic device 16 or/and infrared devices into the housing 10.

1. A device for radial in depth skin therapy, comprising a housing 10, a cylinder 6 fixed in the housing 10, a ball 4 or several balls, inserted in the cylinder 6, and a connector 12 for a suction system, characterized in that inside the device an active chamber (20) is created between the down side of the cylinder (6), where the wall of the cylinder (6) is wider so as to extend closely to the wall of the housing (10), and the lower part of the bell-shaped housing (10) with its specially formed bottom edge (8).

2. A device according to claim 1 characterized in that during the massaging procedure a characteristic skin fold (14) in a shape of a ring is formed in the active chamber (20) as a result of a lower pressure, produced by the suction system connected to the device for radial in depth skin therapy through connector (12).

3. The device according to claims 1 and 2 characterized in that the bottom edge (8) of the housing (10) has a shape of an outwardly bended revers with a smoothly polished surface to enable tight and painless contact with the patient's skin as well as massaging movements in all directions.

4. The device according to claims 1 to 3 characterized in that a ball (4) or several balls or ball like bodies are inserted in the cylinder (6) in such a way, that they can revolve freely and that they project out of the cylinder (6).

5. A device according to claims 1 to 4 characterized in that an ultrasonic head (16) can be build in in the housing (10).

6. A device according to claims 1 to 5 characterized in that its interior can be heated by arbitrary positioned infrared heating sources.
